(19) United States
(12) Patent Application Publication
(10) Pub. No.: US 2013/0092613 A1
(43) Pub. Date: Apr. 18, 2013

(54) BOARD HAVING THE FUNCTIONS OF DRAINING, BLOCKING, CONTAINING, AND COLLECTING WATER

(71) Applicants: Due Hurn Ko, Seoul (KR); Duk No An, Pyoungtaek-si (KR)

(72) Inventors: Due Hurn Ko, Seoul (KR); Duk No An, Pyoungtaek-si (KR)

(21) Appl. No.: 13/271,699

(22) Filed: Oct. 12, 2011

(51) Int. Cl. B01D 29/00

(52) U.S. Cl. 210/153

(57) ABSTRACT

The present invention provides a board having the functions of draining, blocking, containing, and collecting water, in which only a single draining board is installed at a place requiring smooth drainage so that a water-draining function, a water-blocking function, a water-containing function, and a water-collecting function can be all performed, thereby avoiding the necrosis and withering of landscaping trees. The inventive board includes: a coupling structure for drainage including a lower water-draining board and an upper water-draining board disposed on the lower water-draining board; and a filter disposed to surround the coupling structure for drainage in a tightly sealed state, the filter having a coefficient of permeability of more than 0.001 cm/sec in the vertical direction. The lower-water-draining board includes a pair of opposed vertical portions extending upwardly from both end edges thereof in such a fashion as to be flush with the top surface of the first protrusions.

### BACKGROUND OF THE INVENTION

1. Field of the Invention

The present invention relates to a board having the functions of draining, blocking, containing, and collecting water, and more particularly, to such a board having the functions of draining, blocking, containing, and collecting water, which is installed at places requiring smooth drainage, for example, such as a golf driving range, a tennis court, a sports ground, a landfill site, a park, a playground, a tunnel, a retaining wall, and the like, so that a water-draining function, a water-blocking function, a water-containing function, a water-collecting function can be all performed, thereby avoiding the necrosis and withering of landscaping trees

2. Background of the Related Art

In general, water has moved in the ground for hundreds of millions of years even without artificial equipment such as pipes or filters. A main supply source of underground water is rainwater. The rainwater falling on the ground permeates into the ground along soil and narrow gaps in the rock so that supply and demand between the underground water and the rainwater are brought into complete balance.

Recently, the damage of nature due to artificial activities such as building construction, logging, mine development, golf course construction, or the like hinders natural circulation of water. Thus, gravels or stones are frequently used to facilitate the circulation of water in a ground stabilization construction for a golf course, a tennis court, a sports ground, and the like, or a drainage layer construction for the landscaping on a top of an artificial ground plane.

However, since such a method entails a problem in that the work is difficult and much labor and time is required, a drain board made of a synthetic resin material is mostly used recently. An example of such a drain board is shown in FIGS. 5 and 6.

FIGS. 5 and 6 are cross-sectional views illustrating examples of a conventional draining board.

As shown in shown in FIG. 5, a conventional draining board 11 includes a sheet of a predetermined area having a plurality of protrusions 12 protrudingly formed on a flat surface of the sheet, and a non-woven fabric 13 disposed on a top surface thereof.

Such a conventional draining board 11 is operated such that water is introduced into the draining board through the non-woven fabric 13 and then is drained to the outside through spaces defined between the protrusions 12.

However, the conventional draining board 11 encounters a drawback in that since water introduced into the draining board through the non-woven fabric 13 is totally drained to the outside, i.e., the draining board does not possess a water-containing function, landscaping trees wither away and die because there is a deficiency of moisture in the upper soil layer. Besides, since the water introduced into the draining board is totally drained and flows out along both ends of the draining board 11, the drained water cannot be collected in a water storage tank.

In addition, as shown in FIG. 6, the conventional draining board 11 includes a sheet of a predetermined area having a plurality of protrusions 12 protrudingly formed beneath a flat surface of the sheet in a vertically inverted shape of the protrusions 12 shown in FIG. 5, and a non-woven fabric 13 disposed on a top surface thereof. Each of the protrusions 12 of the draining board 11 has a through-hole 14 formed on the bottom thereof. In this case, the draining board 11 still has a problem in that it does not permit water to be drained horizontally despite possessing a water-containing function of retaining water inside the protrusions 12, and hence roots of landscaping trees are rotted away due to a water-gathering portion remaining on an artificial ground.

As such, the conventional draining board has lots of problems in that since it does not have the functions of draining, blocking, containing, and collecting water, a drain board necessary for each function must be selectively installed, etc.

### SUMMARY OF THE INVENTION

Accordingly, the present invention has been made in order to solve the above-mentioned problems occurring in the prior art, and it is an object of the present invention to provide a board having the functions of draining, blocking, containing, and collecting water, in which only a single draining board is installed at a place requiring smooth drainage so that a water-draining function, a water-blocking function, a water-containing function, and a water-collecting function can be all performed, thereby avoiding the necrosis and withering of landscaping trees.

To achieve the above object, the present invention provides a board having the functions of draining, blocking, containing, and collecting water, the board including:

a coupling structure for drainage including a lower water-draining board and an upper water-draining board disposed on the lower water-draining board, wherein the lower water-draining board has one or more first protrusions formed upward-protrudingly from the top surface thereof in such a fashion as to be arranged in a grid array, and a pair of opposed vertical portions extending upwardly from both end edges thereof in such a fashion as to be flush with the top surface of the first protrusions, wherein the upper water-draining board has one or more second protrusions formed downward-protrudingly from the bottom surface thereof in such a fashion as to be arranged in a grid array, and one or more draining holes penetratingly formed between the second protrusions, wherein each of the second protrusions has a water-containing bladder formed therein in such a fashion that it is opened at a top thereof and its inner surface has a concavely recessed contour, and wherein the second protrusions are formed higher than the first protrusions so that the upper water-draining board and the lower water-draining board are disposed to confront each other in such a fashion that the first and second protrusions are alternately arranged with each other; and

a filter disposed to surround the coupling structure for drainage in a tightly sealed state so that the upper and lower water-draining boards are integrally fixed to each other, the filter having a coefficient of permeability of more than 0.001 cm/sec in the vertical direction.

The filter is preferably disposed to surround the upper and lower water-draining boards in its entirety so that the upper and lower water-draining boards are integrally fixed to each other.

In addition, the filter is disposed to cover only the upper water-draining board in such a fashion as to be integrally fixed at both ends thereof to the underside of the lower water-draining board even while the upper and lower water-draining boards are integrally fixed to each other.

Besides, the filter is disposed at both end edges thereof on the underside of the lower water-draining board in a state of being partially thermally bonded to the top surface of the upper water-draining board so that the upper and lower water-draining boards are integrally fixed to each other.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a partially-cut perspective view illustrating a board according to the present invention;

FIG. 2 is a cross-sectional view taken along the line I-I shown in FIG. 1;

FIG. 3 is a cross-sectional view illustrating a modification of the board shown in FIG. 2; and

FIG. 4 is a partially-cut perspective view illustrating the board shown in FIG. 1 in which each of the draining holes 126 of the upper water-draining board 120 is formed in a circular shape;

FIGS. 5 and 6 are cross-sectional views illustrating examples of a conventional draining board.

[Explanation on symbols]

| 100: | coupling structure 100 for drainage | | |
|---|---|---|---|
| 110: | lower water-draining board | 112: | first protrusion |
| 114: | vertical portion | 120: | upper water-draining board |
| 122: | second protrusions | 124: | water-containing bladder |
| 126: | draining hole | 130: | filter |

### DETAILED DESCRIPTION OF THE PREFERRED EMBODIMENTS

Now, a preferred embodiment of the present invention will be descried hereinafter in more detail with reference to the accompanying drawings.

As shown in the drawings, a board having the functions of draining, blocking, containing, and collecting water according to the present invention includes a coupling structure 100 for drainage. The coupling structure 100 includes a lower water-draining board 110 and an upper water-draining board 120, which are disposed to confront each other. The lower water-draining board 110 includes a plurality of first protrusions 112 formed upward-protrudingly from the top surface thereof in such a fashion as to be arranged in a grid array made up of rows and columns. Also, the lower water-draining board 110 includes a pair of opposed vertical portions 114 extending upwardly from both end edges thereof in such a fashion as to be flush with the top surface of the first protrusions 112.

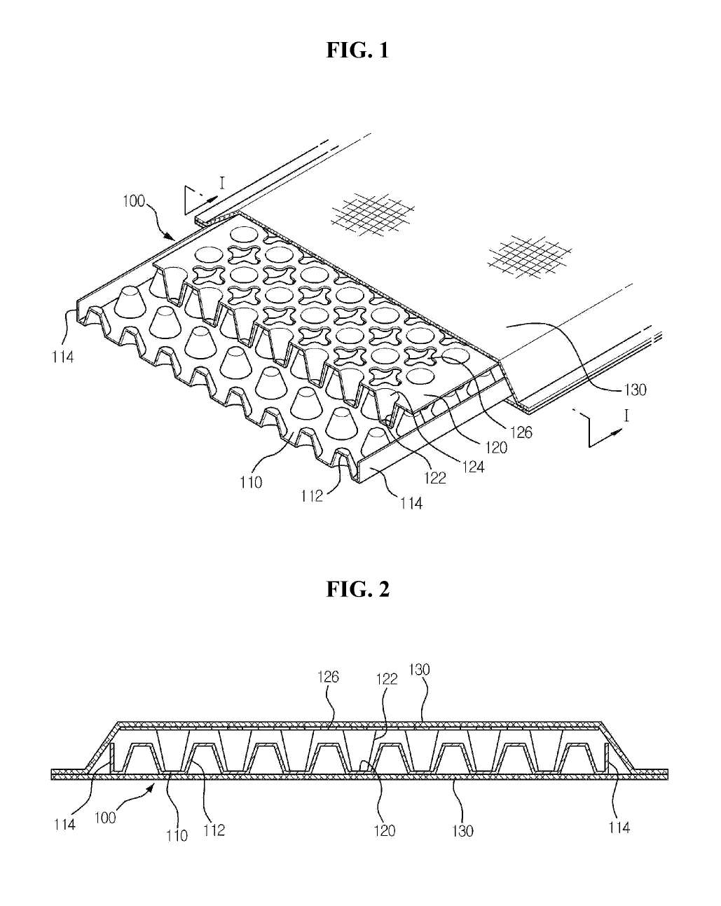

In addition, the upper water-draining board 120 includes a plurality of second protrusions 122 formed downward-protrudingly from the bottom surface thereof in such a fashion as to be arranged in a grid array made up of rows and columns. In this case, each of the second protrusions 122 has a water-containing bladder 124 formed therein in such a fashion that it is opened at a top thereof and its inner surface has a concavely recessed contour. The upper water-draining board 120 has a plurality of draining holes 126 penetratingly formed between the second protrusions 122. In this case, each of the draining holes 126 may be formed in a cross shape as shown in FIG. 1 or may be formed in a circular shape as shown in FIG. 4.

In particular, the coupling structure 100 for drainage is configured such that the second protrusions 122 are formed higher than the first protrusions 112 so that the upper water-draining board 120 and the lower water-draining board 110 are disposed to confront each other in such a fashion that the first and second protrusions are alternately arranged with each other. Thus, the entire thickness of the coupling structure 100 has a value obtained by adding the height of the second protrusions 122 and thickness of the lower water-draining board 110.

The upper and lower water-draining boards 120 and 110 constituting the coupling structure 100 for drainage are made of a synthetic resin material, and water flows and is drained out through the spaces defined between the first and second protrusions 112 and 122, which are interlaced with each other. In other words, since the height of the second protrusions 122 is formed greater than that of the first protrusions 112, water flows and is drained out through the spaces defined between the first and second protrusions 122 and 112, which are alternately arranged with each other. At this time, the water being drained is prevented from flowing out along the both end edges of the lower water-draining board 110 by vertical portions 114 formed extending upwardly from both end edges of the lower water-draining board 110 so that the drained water can be collected in a certain water storage tank.

Moreover, the first and second protrusions 112 and 122 providing the spaces allowing water to flow therebetween are preferably formed in a frusto-conical shape, but may be formed in a truncated-pyramid shape or other various shapes in such a fashion as to be arranged in a grid array made up of equally spaced rows and columns, if necessary.

As shown in FIGS. 1 to 4, the board having the functions of draining, blocking, containing, and collecting water includes a filter 130. The filter 130 is disposed to surround the coupling structure 100 for drainage in a tightly sealed state so that the upper and lower water-draining boards 120 and 110 are integrally fixed to each other. The filter has a coefficient of permeability of more than 0.001 cm/sec in the vertical direction.

Particularly, the filter 130 may be formed of a non-woven fabric material for civil construction, a synthetic resin woven fabric material, or the like. The filter 130 can be manufactured in such a manner as to produce and weave threads by using a synthetic resin such as PP, PE or PET as a raw material. Therefore, water soaked into the ground is introduced into the coupling structure 100 for drainage through the filer 130 and then is drained out.

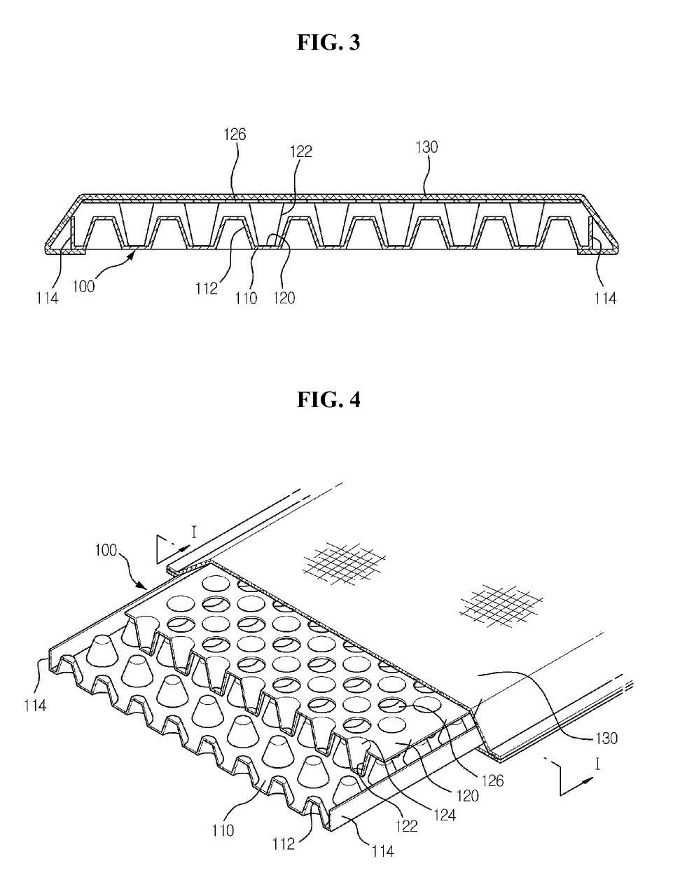

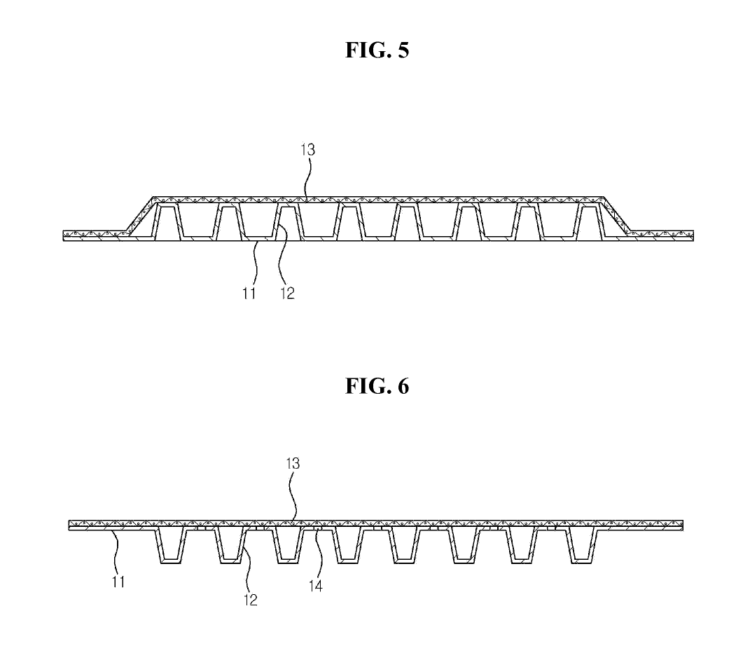

In order to integrally fix the filter 130 to the upper and lower water-draining boards 120 and 110, the filter 130 may be disposed to surround the upper and lower water-draining boards in its entirety so that the upper and lower water-draining boards are integrally fixed to each other as shown in FIG. 2. Alternatively, the filter 130 may be disposed to cover only the upper water-draining board 120 in such a fashion as to be integrally fixed at both ends thereof to the lower water-draining board 110 so that the upper and lower water-draining boards 120 and 110 are integrally fixed to each other as shown in FIG. 3.

In this case, the filter 130 is fixedly disposed in such a fashion that it both ends surround a pair of opposed vertical portions 114 formed extending upwardly from both end edges of the lower water-draining board 110. Thus, when water flows and is drained out through the spaces defined between the first and second protrusions 112 and 122, which are interlaced with each other, the water being drained is prevented from flowing out along the both end edges of the lower water-draining board 110 so that the drained water can be collected in a certain water storage tank.

A thermal bonding, a sewing stitch (i.e., backstitch), or an adhesive can be used as a method for integrally fixing the filter 130 to the coupling structure 100 for drainage. That is, the filter is preferably disposed at both end edges thereof on the underside of the lower water-draining board 110 in a state of being partially thermally bonded to the top surface of the upper water-draining board 120 so that the upper and lower water-draining boards 110 and 120 are integrally fixed to each other.

According to the present invention, the board having the functions of draining, blocking, containing, and collecting water can be constructed at structures requiring smooth drainage, for example, such as a golf driving range, a sports ground, a playground, a tunnel, a retaining wall, and the like.

When it rains in a state in which the board of the present invention is constructed, rainwater being soaked into the ground is permeated through the filter 130. Then, the rainwater is introduced into the coupling structure 100 for drainage through the draining holes 126 penetratingly formed on the upper water-draining board 120. That is, the rainwater is permeated through the filter 130 and then is drained out through the spaces defined between the first and second protrusions 112 and 122 alternately arranged with each other.

In this case, the water introduced into the coupling structure 100 for drainage through the draining holes 126 is drained out only through the spaces defined between the first and second protrusions 112 and 122. In addition, the water is blocked in a vertical direction by a lower portion except the spaces, i.e., the lower water-draining board 110 so that a water-gathering portion does not remain on an artificial ground, thereby preventing roots of landscaping trees from being rotted away.

Particularly, the water being drained is prevented from flowing out along the both end edges of the lower water-draining board 110 by vertical portions 114 formed at both end edges of the lower water-draining board 110 so that the drained water can be collected in a certain water storage tank.

Further, some of the rainwater being permeated through the filter 130 is contained in the concavely recessed water-containing bladders 124 formed by the second protrusions 122 to solve a deficiency of moisture, thereby preventing the landscaping trees from withering away and dying. That is, the water-containing bladders 124 are configured to contain the amount of water enough to solve the deficiency of moisture in soil so that the landscaping trees can be prevented from withering away and dying.

As described above, the present invention has an advantageous effect in that a single draining board is installed in which the upper and lower water-draining boards are integrally fixed to each other by the filter so that a water-draining function, a water stoppage function, a water-containing function, and a water collecting can be performed. That is, the present invention does not allow the water-gathering portion to remain on an artificial ground, allows water to be rapidly drained out, and allows some of the rainwater permeated through the filter to be contained in the water-containing bladders so that necrosis and withering of landscaping trees can be avoided.

In addition, the present invention has an advantageous effect in that the draining board in which the upper and lower water-draining boards are integrally fixed to each other by the filter is constructed as a single product so that the construction time can be reduced, and the construction is possible even without a separate sub-material, thereby reducing the construction cost.

While the present invention has been described in connection with the exemplary embodiments illustrated in the drawings, they are merely illustrative embodiments, and the invention is not limited to these embodiments. It is to be understood that various equivalent modifications and variations of the embodiments can be made by a person having an ordinary skill in the art without departing from the spirit and scope of the present invention. Therefore, various embodiments of the present invention are merely for reference in defining the scope of the invention, and the true technical scope of the present invention should be defined by the technical spirit of the appended claims.

1. A board having the functions of draining, blocking, containing, and collecting water, the board comprising:
a coupling structure for drainage including a lower water-draining board and an upper water-draining board disposed on the lower water-draining board, wherein the lower water-draining board has one or more first protrusions formed upward-protrudingly from the top surface thereof in such a fashion as to be arranged in a grid array, and a pair of opposed vertical portions extending upwardly from both end edges thereof in such a fashion as to be flush with the top surface of the first protrusions, wherein the upper water-draining board has one or more second protrusions formed downward-protrudingly from the bottom surface thereof in such a fashion as to be arranged in a grid array, and one or more draining holes penetratingly formed between the second protrusions, wherein each of the second protrusions has a water-containing bladder formed therein in such a fashion that it is opened at a top thereof and its inner surface has a concavely recessed contour, and wherein the second protrusions are formed higher than the first protrusions so that the upper water-draining board and the lower water-draining board are disposed to confront each other in such a fashion that the first and second protrusions are alternately arranged with each other; and
a filter disposed to surround the coupling structure for drainage in a tightly sealed state so that the upper and lower water-draining boards are integrally fixed to each other, the filter having a coefficient of permeability of more than 0.001 cm/sec in the vertical direction.

2. The board according to claim 1, wherein the filter is disposed to surround the upper and lower water-draining boards in its entirety so that the upper and lower water-draining boards are integrally fixed to each other, or is disposed to cover only the upper water-draining board in such a fashion as to be integrally fixed at both ends thereof to the underside of the lower water-draining board even while the upper and lower water-draining boards are integrally fixed to each other.

3. The board according to claim 1, wherein the filter is disposed at both end edges thereof on the underside of the lower water-draining board in a state of being partially thermally bonded to the top surface of the upper water-draining board so that the upper and lower water-draining boards are integrally fixed to each other.

4. The board according to claim 2, wherein the filter is disposed at both end edges thereof on the underside of the lower water-draining board in a state of being partially thermally bonded to the top surface of the upper water-draining board so that the upper and lower water-draining boards are integrally fixed to each other.
